(19) United States
(12) Patent Application Publication
(10) Pub. No.: US 2009/0011183 A1
(43) Pub. Date: Jan. 8, 2009

(54) Biaxially Oriented Polypropylene Film for Labels

(75) Inventors: Karl-Heinz Kochem, Neunkirchen (DE); Mathias Roth, Zweibrucken (DE); Wilfrid Tews, Bechhofen (DE); Gerhard Wieners, Frankfurt (DE)

Correspondence Address: CONNOLLY BOVE LODGE & HUTZ, LLP, P O BOX 2207, WILMINGTON, DE, 19899, US

(73) Assignee: Treofan Germany GmbH & Co. KG, Neunkirchen (DE)

(21) Appl. No.: 11/578,227

(22) PCT Filed: Apr. 13, 2005
(86) PCT No.: PCT/EP05/51613

§ 371 Date: Sep. 24, 2008

(30) Foreign Application Priority Data
Apr. 15, 2004 (DE) 10 2004 018 258.2

(51) Int. Cl. B32B 7/00; B29C 45/14

(52) U.S. Cl. 428/119; 264/279.1

(57) ABSTRACT

The invention relates to a multi-layered biaxially oriented polypropylene film consisting of a base layer, a covering layer (I) which is applied to a first side of the film and contains at least between 80 and 100 wt. % of a propylene-ethylene copolymer, and another layer (II) which is applied to the opposing second side and contains between 40 and 100 wt. % of a propylene-ethylene copolymer. The propylene-ethylene copolymer of the two layers contains a maximum of 2.5 wt. % of ethylene and has a melting point between 145 and 160° C. The curl of the film can be controlled very well.

The present invention relates to a polypropylene film, the curling tendency of which can be selectively adjusted, and its use as label film, in particular its use as in-mould label, and a method for producing these films.

Label films comprise an extensive and technically complex field. Various labelling technologies are differentiated, which differ with regard to the process conditions and which impose varying technical requirements on the label materials. All labelling methods have in common that visually appealing labelled containers must result as the final product, in which good adhesion of the label to the container must be ensured.

In the labelling methods, greatly varying technologies are used for applying the label. A distinction is made between self-adhesive labels, wrap-around labels, shrink labels, in-mould labels, patch labelling, etc. The use of a film made of thermoplastic synthetic material as label is fundamentally possible in all of these different labelling methods.

All in-mould labelling methods have in common that the label takes part in the actual moulding process of the container and is applied during the latter. Different moulding processes are used here, such as, for example, injection moulding processes, blow moulding processes and deep drawing processes.

In the injection moulding process, a label is laid in the injection mould and a molten liquid plastic is injected behind it. Due to the high temperatures and pressures, the label bonds to the injection moulded part, becoming an integral, non-detachable component of the moulded piece. Tubs and lids for ice cream or margarine packaging, for example, are produced using this process.

Individual, mostly pre-printed labels are hereby taken from a stack or cut from a roll and laid in the injection mould. The mould is configured in this case in such a way that the melt flow is injected behind the label and the printed front side of the film is in contact with the wall of the injection mould. During the injection, the hot melt bonds to the label. Subsequent to the injection, the mould opens, and the moulded piece with label is ejected and cools down. In the result, the label must adhere to the container in a crease-free and visually sound manner.

During injection, the injection pressure is in a range from 300 to 600 bar. The plastics used have a melt flow index of around 40 g/10 min. The injection temperatures depend on the plastic employed. In some cases, the mould is additionally cooled in order to avoid sticking of the labelled moulding to the mould.

In deep drawing, unoriented thick plastic slabs, mostly cast PP (polypropylene) or PS (polystyrene), in a thickness of approx. 200 μm, are warmed and drawn or pressed into a corresponding mould by means of vacuum or stamping tools. Here too, the individual label is laid in the mould and bonds to the actual container during the moulding process. Since considerably lower temperatures are used, the adhesion of the label to the container may be a critical factor. Good adhesion must also be ensured at these low processing temperatures. The processing speeds in this process are lower than in injection moulding.

Direct in-mould labelling is also possible in blow forming of containers or hollowware. In this process, a melt tube is extruded vertically downward through an annular die. A vertically divided mould moves together and encloses the tube, which is squeezed at the lower end in the process. At the upper end, a blow pin is inserted, through which the opening of the moulding is implemented. Air is supplied to the warm melt tube via the blow pin, causing it to expand and come into contact with the inside walls of the mould. In the process, the label must bond to the viscous plastic of the melt tube. The mould is subsequently opened and the excess length is cut off at the moulded opening. The moulded and labelled container is ejected and cools down.

In these blow-moulding processes, the pressure during inflation of the melt tube is about 4-15 bar and the temperatures are significantly lower than in injection moulding. The plastic materials have a lower MFI than in injection moulding in order to form a dimensionally stable melt tube and therefore behave differently than the low-viscosity materials for injection moulding.

In these blow-moulding processes, biaxially oriented films made of thermoplastic synthetic material are also increasingly employed for labelling of containers during moulding. For this, the films must have a selected property profile in order to ensure that the label film and the blown moulding come into smooth and bubble-free contact with one another and bond to one another.

When using polypropylene films in the different labelling methods, different problems still arise, for which no satisfactory solution has yet been found. For example, in in-mould processes, sometimes the outer side of the label film sticks to the mould in which the label is laid and thus disruptions occur in the production cycle. This sticking may occur due to adhesion of the printing inks to the surface of the injection mould in the printed region of the label or, if the printing does not cover the entire area, due to excessively strong adhesion of the unprinted film surface to the mould. The film sticks to the mould and is more or less torn upon opening. Label residues remain suspended in the mould and the moulded container is not correctly labelled and must be discarded.

Errors of this type are caused in part by contamination of the moulds, which may arise after longer production cycles For example, components of printing inks accumulate on the surface of the mould, which undesirably favour this sticking. This problem is partly related to the specific conditions during moulding. Thus, temperatures and injection pressure during in-mould injection moulding are especially high, so that the entire film is briefly heated strongly in the region of the injection point and simultaneously pressed to the mould in this region by a high injection pressure. Because of these conditions, problems increasingly occur precisely in this region due to sticking to the mould. The film tears in the region of the injection point, delaminates, and finally hangs in shreds, partially on the inside of the mould and partially on the surface of the container.

This undesired delamination often occurs in so-called opaque films, whose mechanical strength, due to vacuoles inside the film, is weaker than with comparable transparent or white pigmented embodiments. The lower the density, the worse the labels can withstand the mechanical stresses during in-mould labelling. This appears understandable, since the mechanical strength of the polymer matrix becomes weaker if the density is reduced further by more and more vacuoles. However, films having lower density are required by the users precisely in the labelling sector, since the reduced density offers a higher surface yield and therefore lower costs.

EP 0 715 951 describes a multi-layered opaque film having improved tendency to split. The film has an at least three-layer structure consisting of a base layer and at least one intermediate layer applied on the base layer and a surface layer lying thereon. The base layer contains 2 to 30% by weight vacuole-initiating particles to reduce the density. The intermediate layer additionally contains 1 to 25% by weight vacuole-initiating particles and at least 2% by weight TiO₂. The film is characterized by different structures of the intermediate and base layer, through which a high degree of whiteness is achieved in connection with low tendency to split and low area weight. However, these films are subject to the disadvantage that the vacuole-containing intermediate layer negatively influences the gloss of the film.

EP 0 321 843 describes a film having improved inherent delamination stability, which is built up from a base layer and two transparent surface layers. The base layer contains a mixture of polypropylene, fillers for generating the vacuoles, and 5 to 30% by weight of a hydrocarbon resin. According to this teaching, the addition of resin improves the delamination stability of the films. However, these films are subject to the disadvantage that resin is a problematic component. Firstly, the use of resin increases the raw material costs. Volatile components of the resins may vaporize and lead to deposits on the rolls during the production or processing of the film. Finally, the resin increases the blocking tendency of the film and leads to problems when unstacking during processing.

DE 39 33 695 describes a non-sealable film comprising a base layer made of polypropylene and at least one surface layer, which is built up from a special ethylene-propylene copolymer. This copolymer is characterized by an ethylene content of from 1.2 to 2.8% by weight and a distribution factor of >10 and a melting enthalpy of >80 J/g and a melt flow index of from 3 to 12 g/10 min (21.6 N and 230° C.). It is described that the properties of the copolymer must be kept within these narrow limits to improve the printability and the visual properties.

A further problem when using polypropylene films as labels is the curling tendency of the polypropylene film. Films are web goods which are wound to large rolls during production. In the packaging sector, the films are processed in form of rolled goods. For this reason, no problems arise in the usual packaging applications as a result of the curling tendency of the film. When processing the films to labels, the wound web product is often cut into sheets, stacked and provided with a printing. Arbitrarily cut labels are punched out from the printed sheets and stacked. In some processes the printing of the rolled goods is carried out first. Here too, however, the corresponding label is cut or punched out of the printed roll prior to the application. These for example rectangular or circular cut-outs of arbitrary size are then utilized in the labelling process. For a trouble-free process, the pre-cut label must lie as flat as possible; the label shall, in particular, not bend in the “wrong” direction, i.e. in the direction of the printed outer surface, when applied. This so-called “curling” of the polypropylene films is extremely disturbing when using the film as label. The problem has not been satisfactorily resolved to date. A further difficulty is that the curling tendency may be additionally adversely influenced by the printing of the film. After drying of the printing ink, the printed sheets have a particularly strong curling tendency toward the printed side. The tendency to curl disrupts when film is used in the different labelling processes, particularly when label films are employed in the in-mould process.

In the prior art it has been proposed to control the curling tendency of polypropylene films through the ratio of the layer thicknesses. Accordingly, EP 0 862 991 describes a multi-layer opaque film, which comprises an opaque vacuole-containing base layer. Additional intermediate layers or surface layers not containing any vacuoles are applied to both sides of this base layer. According to this teaching, the combined thickness of the surface layers and intermediate layers on one side shall be twice as large as the corresponding total thickness of the additional layers on the other side of the base layer.

These and other known measures for adjusting the flatness are based on an unstable equilibrium of forces, which is sometimes disturbed for no immediately apparent reason. Accordingly, slight variations in the quality of the raw materials, fluctuations in the thickness of individual layers, the proportion of recycled material in the films or varying process conditions, in practice often lead to an unexpected curling tendency, mostly toward the outside, which is especially undesirable and is frequently complained about by the customer. Valuable production time is often lost until the parameter is found, through which the curling tendency/flatness can be readjusted.

In the scope of the investigations to the present invention, it was found that the curling tendency is not always reliably controlled through the layer thicknesses. For example, WO 2004/014650 describes a film which, for improving the delamination on the outer surface, comprises a surface layer made of a “mini-copolymer”, in order to reduce the sticking of the label to the mould. According to WO 2004/014650, it was found that these structures have an unexpectedly strong tendency to curl toward the glossy side, even though the improved effect on the delamination resistance is very advantageous.

It is therefore the object of the present invention to provide a film which has good flatness characteristics. The object is also to modify films having a glossy outer surface and, where applicable, having a matt inner surface for labelling applications in such a way that the film exhibits a tendency to curl toward the inside.

Furthermore, it is an object of the present invention to provide an opaque film having low density, which is to have improved mechanical stability during in-mould labelling and good flatness characteristics. In consideration of a good yield, in some applications the film is to have a reduced density, generally less than 0.7 g/cm³, but be reliably usable in the different in-mould labelling methods, without delamination of the film taking place when opening the mould or disturbances occurring as a result of curling tendencies of the film.

It is understood that the desired usage properties of the film in regard to its use as a label film must otherwise be maintained. Consequently, for example, the film is still to have a good visual appearance, possibly a high degree of whiteness, good printability, and good antistatic properties with respect to the unstacking ability, etc.

The object upon which the present invention is based is achieved by a multi-layered biaxially oriented polypropylene film comprising a base layer and a surface layer I, which contains at least 80 to 100% by weight of a propylene-ethylene copolymer, wherein at least one further layer II is applied to the opposing side, which contains 40 to 100% by weight of a propylene-ethylene copolymer, with the propylene-ethylene copolymer of the two layers containing a maximum of 2.5% by weight of ethylene and having a melting point in the range from 145 to 160° C.

The present invention is based on the discovery that the use of a mini-copolymer in only one surface layer of a multi-layered polypropylene film generates a strong tendency to curling in the direction of this mini-copolymer surface layer. The occurrence of the curling tendency, which is observed even with the thinnest surface layers made of this polymer, is surprisingly high. Films with a comparable structure and a corresponding surface layer made of normal sealable propylene copolymers or conventional isotactic propylene homopolymers do not present such a characteristic curling tendency, so that, in the case of these films, the flatness can normally be adjusted through process conditions and layer thicknesses, such as is described in EP 0862 991, for example.

It was found, however, that for structures with only one mini-copolymer surface layer, i.e. when the said copolymer is only available on one side of the film, the tendency to curl in the direction of this layer is so pronounced, that this tendency to curl can no longer be compensated by variations in the process conditions or layer thicknesses.

Despite this disadvantageous curling tendency, the application of mini-copolymers in the outer surface layer is desirable for some applications, for example for improving the initial tear resistance, since films comprising a “normal” polypropylene copolymer surface layer having an ethylene content greater than 3% by weight and a melting point of less than 145° C. and a melting enthalpy of less than 80 J/g have significantly lower initial tear resistances, as described in WO 2004/014650.

Within the scope of the present invention, it was found that, starting from a film comprising only one mini-copolymer surface layer on the outer side, good flatness can be achieved if mini-copolymers are additionally incorporated into at least one further layer II on the opposing inner surface. This layer II on the inner side can be a surface layer II or an intermediate layer II, wherein this layer II must contain at least 40 to 100% by weight of mini-copolymers, that is, the mini-copolymer can also be mixed with a further polymer different from it in the respective layer II. Surprisingly, this film structure according to the invention also enables to control and selectively adjust the curling tendency of polypropylene films, i.e. to produce films having stable flatness characteristics or having a slight tendency to curl in the direction of the inner side of the label. The latter may be desirable, if the application of the label on the container to be labelled is facilitated as a result of this tendency. Furthermore, the tendency to curl towards the outside induced by printing ink can be advantageously compensated. For this reason, the special significance of the invention is that a dominating effect was found, which enables the targeted control and adjustment of the curling tendency.

Within the context of the present invention, the two opposing sides of the label film will be referred to as outer side and inner side. The outer side is the side which is visible subsequent to the application of the film as label on the container and is therefore generally provided with a decorative or informative printing. The inner side faces the container. In practice, the film is often high-gloss finished on the inner side, which is why this side is also referred to as glossy side. Particularly for in-mould applications, the inner side has an increased surface roughness, which causes a matt appearance. This side of the label is therefore also referred to as matt side. For this reason, the surface layers and intermediate layers on the glossy side and the matt side are referred to as opposing layers, i.e. they are disposed on this side and on the other side of the base layer. The surface layer made of mini-copolymer on the outer side of the film is hereinafter referred to as surface layer I. Surface layer II and intermediate layer II are the corresponding layers made of mini-copolymer on the inner side of the film. The notation with the Roman numerals I or II is therefore only used for those layers which contain mini-copolymer. In contrast thereto, further layers containing other polymers are referred to as first or second surface layer or intermediate layer. Intermediate layers are located between the base layer and the surface layer. Surface layers are layers located outside.

In the sense of the present invention, mini-copolymers are propylene-ethylene copolymers having an ethylene content of up to 2.5% by weight, preferably of from 0.3 to <2.0% by weight, particularly >1 to 1.8% by weight. The melting point is in a range from 145 to 160° C., preferably from 148 to 155° C., particularly 150 to <155° C. The melting enthalpy is usually in the range from 80 to 110 J/g, preferably from 90 to 100 J/g. The melt flow index is generally 3 to 15 g/10 min, preferably 3 to 9 g/10 min (230° C., 21.6 N DIN 53735). Moreover, the copolymers are preferably characterized by a high distribution factor, which is generally greater than 70, preferably lying between 80 and 100. It is thereby characterized if the ethylene components are built into the propylene chain individually or in blocks. This kind of distribution factors can be determined from the ¹³C-NMR spectrum of the copolymer.

The surface layer I (outer side) contains at least 80% by weight, preferably 90 to 100% by weight, particularly 95 to <100% by weight of the described mini-copolymer. Besides this main component, the surface layer may contain conventional additives, such as antiblocking agents, lubricants, antistatic agents, stabilizers and/or neutralization agents in effective amounts in each case, although generally no vacuole-initiating fillers, i.e. the surface layer I is free from vacuoles. If required, small quantities of a second different propylene polymer may be contained, the proportion of which, however, is less than 20% by weight, in particular 0 to 10% by weight, in particular >0 to 5% by weight. Such embodiments are not preferred, but possible if, for example, additives are incorporated via concentrates, which are based on another polymer, such as, for example, propylene homopolymer or other propylene copolymers.

The thickness of this surface layer I has a significant influence on the curling tendency of the film, meaning that the thicker the surface layer I, the stronger the curling tendency acts in the direction of this surface layer I or the less pronounced is an existing tendency to curl toward the inner side of the film. Since flatness or a slight tendency to curl toward the inner side is generally desired, in practice, a thin layer thickness in the range from 0.1 to 3 μm, preferably 0.5 to 1.5 μm, will be selected for the surface layer I having at least 80% by weight of mini-copolymers. If the thickness of the surface layer I is greater than 3 μm, the acting forces are so large that the tendency to curl toward the outer side can only be compensate with difficulty using a layer II on the inner side. The selection and composition of these layers II is then very limited and is only aimed at finding a way to achieve flatness.

When the surface layer I additionally contains a small amount, for example 5 to 15% by weight of a further polymer different therefrom, a slightly greater layer thickness of up to 5 μm can be selected, if required, since the additional polymer may weaken the induced curling tendency, although in this case, 0.5 to 1.5 μm are also preferred.

To improve the adhesive properties, especially the printability, the surface of the surface layer I is generally subjected to a process for increasing the surface tension in a way known per se by means of corona, flame or plasma. Typically, the surface tension in the surface layer I thus treated is then in a range from 35 to 45 mN/m.

According to the invention, a further layer II is arranged on the opposite side of the base layer (inner side), which contains at least 40 to 100% by weight mini-copolymer, preferably 55 to 95% by weight, in particular 60 to 90% by weight, and, as the case may be, conventional additives, such as antiblocking agents, lubricants, antistatic agents, stabilizers and/or neutralization agents in effective amounts in each case. Generally, the layer II does not contain any vacuole-initiating fillers, either, which means that it is free from vacuoles as in the case of the surface layer I. The layer II can be a surface layer II and/or an intermediate layer II on the inner side. In a preferred embodiment, the layer II is an intermediate layer II, which is covered by a second surface layer. This embodiment enables the surface of the inner side of the label to be configured by means of the composition of the second surface layer in such a way that it is optimized with respect to the in-mould process or for the incorporation of an adhesive, or that it can be provided with a further printing, if required. If, with regard to specific properties of the film, the intermediate layer is not to be modified with mini-copolymer on the inner side, the layer II with mini-copolymer can also be a surface layer II.

The curling tendency of the film according to the invention depends, for a given thickness and composition of the surface layer I, on the thickness of the layer II as well as on the content of mini-copolymer in the layer II. In addition, it is also relevant if the layer II is a surface layer II or an intermediate layer II. For the same thickness and same composition of a layer II, stronger forces act due to a layer II compared to an intermediate layer II.

In principle, the tendency to curl toward the inner side is increased (and the tendency to curl toward the inner side is respectively weakened) when using thicker layers II. For a given thickness of the layer II, the tendency to curl in the direction of this layer II is increased by a greater proportion of mini-copolymer in the layer II. Surprisingly, a minimum content of 40% by weight in the layer II is however required in order to compensate the effect of the surface layer I and to obtain good flatness. If the content in the layer II lies below 40% by weight, no flatness can be achieved, also with a significant increase in the thickness of the layer II, even when, as a result of this, the amount of mini-copolymer on the inner side is several times greater than the amount on the outer side. For achieving good flatness it is therefore not only important that a layer of mini-copolymer is provided on each of both sides of the base layer. It is also not sufficient that the same amount is available on each side. The structures formed within the layers obviously play a decisive role as well. It was originally expected for the curling forces to be proportional to the amount of mini-copolymer and flatness to be achieved by adjusting equal amounts on both sides of the base layer. It was found, however, that the relationships are more complex and that several factors must be matched against one another. Surprisingly, the layer II must contain at least 40% by weight mini-copolymer. If the content of mini-copolymer in the layer II is varied within the range relevant to the invention of from 40 to 100% by weight, it is additionally the case that the lower the content of mini-copolymer in the layer II, the greater the thickness of the layer is selected, or, alternatively, the more the mini-copolymer content approaches the 100% by weight, the lower the thickness.

If surface layer I and layer II contain approximately the same amount (difference 0 to 10% by weight) of mini-copolymer, i.e. also the layer II contains more than 80% by weight, preferably more than 90% by weight, then the layer thicknesses (layer II/surface layer I) should only differ slightly from one another. For example, a surface layer II having >80 to 100% by weight mini-copolymer should generally be 0.2 to 1.0 μm thicker than the surface layer I, i.e. 0.3 to 4.0 μm; or up to 6 μm thick, preferably 0.5 to 3.0 μm. If the layer II is, for example, an intermediate layer II having >80 to 100% by weight mini-copolymer, then this intermediate layer II should be 0.5 to 3 μm thicker than the surface layer I, i.e. 0.6 to 6 μm, preferably 1.5 to 5 μm.

If the layer II contains a mixture of 40 to 80% by weight of mini-copolymer and at least 20 to 60% by weight of a further polymer, the layer II is always thicker than the surface layer I, preferably at least 1 μm thicker, in particular 1.5 to 6 μm thicker, i.e. the thickness of this layer II varies strictly from >1.0 to 9 μm, and up to 11 μm, respectively. The lower the content of mini-copolymer in the layer II, the more the thickness of the layer II should exceed the thickness of the surface layer I. The thickness of an intermediate layer II having 40 to 80% by weight of mini-copolymer lies preferably in the range from 1.1 to 11 μm, in particular 1 to 8 μm. The thickness of a mixed surface layer II is preferably 1.1 to 5 μm.

It was found that the sums of the layer thicknesses on this side and on the other side of the base layer are not relevant to the curling tendency of the films according to the invention. The mini-copolymers cause curling forces which are significantly larger than for comparable films made of propylene homopolymer layers or propylene copolymer layers. The ratio of the thicknesses of the mini-copolymer layers I/II and the composition thereof essentially determine the tendency to curl and the flatness, respectively.

In individual cases, the selection of the layer thicknesses and their composition will also depend on the curling tendency of the respective basic structure. If additional tendency to curl toward the outside is caused by the remaining layers, due to process conditions or due to printing, the layer thickness of the surface layer I must then be correspondingly reduced or the thickness and/or the composition of the layer II adapted, for example. Being aware of the previously described relationships, the person skilled in the art will easily find the matching layer thicknesses and compositions by means of a manageable number of tests.

For example, high-gloss finished label films according to the invention have, for the purpose of increasing the gloss, on the outer side between the opaque, vacuole-containing base layer and the surface layer I, a thick intermediate homopolymer layer of from 3 to 6 μm, which increases the tendency to curl in the direction of the outer side. The dominating effect, however, is the strong curling tendency due to the surface layer I, in particular if this contains almost 100% by weight mini-copolymer, even when its thickness is, for example, only 0.5 to 1 μm. For this reason, in the case of such a film structure, the targeted optimal thickness of the intermediate layer II to achieve flatness will be in the range from 1 to 1.5 μm, if, as in the case of the surface layer I, the intermediate layer II consists of mini-copolymer. If, with regard to other usage properties or for process related reasons, the layer thickness II is to be increased to, for example, by 3 to 4 μm, then the mini-copolymer can be mixed with a propylene homopolymer in order to obtain the good flatness characteristics.

In the mixtures having at least one further polymer, the mini-copolymer can essentially be mixed with all the conventional polyolefins which are employed in biaxially oriented polypropylene films. The layer II generally contains 0 to 60% by weight of polyolefin, preferably 5 to 45% by weight, in particular 10 to 40% by weight and, if applicable, additional conventional additives in effective amounts, in each case.

Isotactic propylene homopolymers are preferably used as mixing component, which are basically built up from propylene units and have a melting point of from 158 to 170° C., and generally have a melt flow index of from 0.5 to 8 g/10 min, preferably 2 to 5 g/10 min, at 230° C. and under a force of 21.6 N (DIN 53735) and an isotacticity of from 92 to 98% and an n-heptane-soluble proportion of less than 15% by weight.

In addition, the mini-copolymer in the layer II may also be mixed with sealable propylene copolymers and/or propylene terpolymers, in which case these copolymers differentiate themselves in any case from the previously described mini-copolymers by the ethylene content and the melting point. Suitable propylene copolymers or terpolymers have a melting point of <145° C. and are generally made of at least 80% by weight propylene and ethylene and/or butylene units as comonomer. Preferred mixed polymers are random ethylene-propylene copolymers having an ethylene content of from >2.5 to 10% by weight, preferably 3 to 8% by weight, or random propylene-butylene-1 copolymers having a butylene content of from 4 to 25% by weight, preferably 10 to 20% by weight, each in relation to the total weight of the copolymer, or random ethylene-propylene-butylene-1 terpolymers having an ethylene content of from 1 to 10% by weight, preferably 2 to 6% by weight, and a butylene-1 content of from 3 to 20% by weight, preferably 8 to 10% by weight, each in relation to the total weight of the terpolymer. These copolymers and terpolymers generally have a melt flow index of from 3 to 15 g/10 min, preferably 3 to 9 g/10 min (230° C., 21.6 N DIN 53735) and preferably a melting point of from 70 to <140° C., in particular 90 to 140° C. (DSC).

According to the teaching of the invention, in embodiments comprising mixtures in the layer II, the curling tendency of the film can be adjusted to the desired extent via two parameters. The invention therefore provides great flexibility. If, for example, for process related reasons there is a pre-established maximum thickness of the intermediate layer II, which is however insufficient for achieving flatness, the content of mini-copolymer in the intermediate layer II can additionally be increased so far that the tendency to curl toward the outer side is fully compensated. Furthermore, the invention enables targeted elimination of undesired curling tendency, which unexpectedly occurs, for example, due to varying raw material quality or different proportions of recycled material. An adaptation of the layer thicknesses or of the content of mini-copolymer in the layers I or II is easy to accomplish and reliably leads to stable flatness.

Besides the described layers made of mini-copolymer, the film comprises further layers made of polyolefins, as the case may be. The composition and thickness of these further layers can be selected, in principle, in an arbitrary manner, depending on the requirements of the respective label application. The further layers generally contain at least 80% by weight, preferably 90 to <100% by weight of olefinic polymers or mixtures thereof. Suitable polyolefins are, for example, polyethylenes, propylene homopolymers (as described for the base layer), propylene copolymers, and/or propylene terpolymers.

Isotactic propylene homopolymers are preferably used as polyolefins in the further layers, which are essentially built up from propylene units and have a melting point of from 158 to 170° C., and generally have a melt flow index of from 0.5 to 8 g/10 min, preferably 2 to 5 g/10 min, at 230° C. and under a force of 21.6 N (DIN 53735) and an isotacticity of from 92 to 98% and an n-heptane-soluble proportion of less than 15% by weight.

In addition, sealable propylene copolymers and/or propylene terpolymers can be used, in which case these copolymers differentiate themselves in any case from the previously described mini-copolymers by the ethylene content and the melting point. Suitable propylene copolymers or propylene terpolymers have a melting point of <145° C. and are generally made of at least 80% by weight of propylene and ethylene and/or butylene units as comonomer. Preferred mixed polymers are random ethylene-propylene copolymers having an ethylene content of from >2.5 to 10% by weight, preferably 3 to 8% by weight, or random propylene-butylene-1 copolymers having a butylene content of from 4 to 25% by weight, preferably 10 to 20% by weight, each in relation to the total weight of the copolymer, or random ethylene-propylene-butylene-1 terpolymers having an ethylene content of from 1 to 10% by weight, preferably 2 to 6% by weight, and a butylene-1 content of from 3 to 20% by weight, preferably 8 to 10% by weight, each in relation to the total weight of the terpolymer. These copolymers and terpolymers generally have a melt flow index of from 3 to 15 g/10 min, preferably 3 to 9 g/10 min (230° C., 21.6 N DIN 53735) and preferably a melting point of from 70 to <140° C., in particular 90 to 140° C. (DSC).

Suitable polyethylenes are, for example, HDPE, MDPE, LDPE, LLDPE, VLDPE, of which the HDPE and MDPE types are particularly preferred. HDPE generally has an MFI (50 N/190° C.) of greater than from 0.1 to 50 g/10 min, preferably 0.6 to 20 g/10 min, measured in accordance with DIN 53735 and a viscosity number, measured in accordance with DIN 53728, part 4, or ISO 1191, in the range from 100 to 450 cm³/g, preferably 120 to 280 cm³/g. The crystallinity is 35 to 80%, preferably 50 to 80%. The density, measured at 23° C. in accordance with DIN 53479, method A, or ISO 1183, is in the range from >0.94 to 0.96 g/cm³. The melting point, measured using DSC (maximum of the melting curve, heating speed 20° C./min), is between 120 and 140° C. Suitable MDPE generally has an MFI (50 N/190° C.) of greater than 0.1 to 50 g/10 min, preferably 0.6 to 20 g/10 min, measured according to DIN 53735. The density, measured at 23° C. according to DIN 53479, method A, or ISO 1183, is in the range from >0.925 to 0.94 g/cm³. The melting point, measured using DSC (maximum of the melting curve, heating speed 20° C./min), is between 115 and 130° C.

Such type of further layer is, for example, an intermediate layer on the outer side of the film, which is applied between the base layer and the surface layer I, referred to hereinafter as first intermediate layer. The layer thickness of the first intermediate layer is typically in the range from 2 to 8 μm, preferably 3 to 6 μm.

This first intermediate layer is preferably composed of isotactic polypropylene homopolymer for producing high gloss in a way known per se. The previously described other usual propylene copolymers or propylene terpolymers and mixtures of these polyolefins can also be considered, as the case may be. Furthermore, it is advantageous to modify the first intermediate layer with a typical amount of from 2 to 12% by weight of TiO₂, in order to increase the degree of whiteness. Such a first intermediate layer will generally not exhibit any vacuoles.

Embodiments comprising an intermediate layer II have as further layer a second surface layer on the inner side of the film, the thickness of which can vary in the range from 1 to 5 μm. With regard to using the film as in-mould label film, a mixture made of the described propylene copolymers and/or propylene terpolymers and the cited polyethylenes is particularly preferred for the second surface layer. These surface layer mixtures are advantageous for producing a surface roughness which favourably promotes a bubble-free application and the adhesion of the label in the injection moulding or blow forming process. HDPE- and/or MDPE-containing surface layer mixtures having an HDPE or MDPE content of from 10 to 50% by weight, in particular 15 to 40% by weight are particularly advantageous for this. Sealable surface layers made of conventional propylene copolymers or propylene terpolymers can be selected for other applications.

Embodiments comprising a mini-copolymer surface layer II have, as the case may be, a second intermediate layer between this surface layer II and the base layer, the thickness of which is 1 to 5 μm. This second intermediate layer can be essentially structured in the same way as the second surface layer described in the preceding paragraph, i.e. it can be composed of PE mixtures to support a surface roughness or of conventional propylene copolymer or propylene terpolymers. This second intermediate layer can, if necessary, contain TiO₂ and/or have vacuoles.

The further layers can additionally contain conventional additives in respective effective amounts.

The base layer of the multilayer film contains polyolefin, preferably a propylene polymer and possibly vacuole-initiating fillers and/or pigments, and possibly typical additives in the respective effective quantities. In general, the base layer contains at least 50 to 100% by weight, preferably 60 to 98% by weight, in particular 70 to 95% by weight, of the polyolefin, in each case in relation to the weight of the layer.

Propylene polymers are preferred as the polyolefins of the base layer. These propylene polymers contain 90 to 100% by weight, preferably 95 to 100% by weight, in particular 98 to 100% by weight of propylene units and have a melting point of 120° C. or higher, preferably 150 to 170° C., and generally a melt flow index of from 1 to 10 g/10 min, preferably 2 to 8 g/10 min, at 230° C. and under a force of 21.6 N (DIN 53735). Isotactic propylene homopolymers having an atactic proportion of 15% by weight or less, copolymers of ethylene and propylene having an ethylene content of 5% by weight or less, copolymers of propylene with C₄-C₈ olefins having an olefin content of 5% by weight or less, terpolymers of propylene, ethylene, and butylene having an ethylene content of 10% by weight or less and having a butylene content of 15% by weight or less represent preferred propylene polymers for the base layer, isotactic propylene homopolymer being especially preferred. The % by weights specified relate to the respective polymers.

Furthermore, a mixture made of the cited propylene homopolymers and/or propylene copolymers and/or propylene terpolymers and other polyolefins, particularly made of monomers having 2 to 6 C atoms, is suitable, the mixture containing at least 50% by weight, particularly at least 75% by weight propylene polymer. Suitable other polyolefins in the polymer mixture are polyethylenes, particularly HDPE, MDPE, LDPE, VLDPE, and LLDPE, the proportion of these polyolefins not exceeding 15% by weight in relation to the polymer mixture in each case.

The film according to the present invention is further distinguished by a reduced density, which is caused by vacuoles in the base layer, which simultaneously provide the film with an opaque appearance. “Opaque film” in the sense of the present invention means a non-transparent film, the light transmission (ASTM-D 1003-77) of which is at most 70%, preferably at most 50%.

The opaque base layer contains vacuole-initiating fillers in an amount of no more than 30% by weight, preferably 2 to 25% by weight, in particular 5 to 15% by weight, in relation to the weight of the opaque base layer. Vacuole-initiating fillers are solid particles which are incompatible with the polymer matrix and lead to the formation of vacuole-like cavities when the film is stretched. The vacuoles reduce the density and provide the film with a characteristic nacreous, opaque appearance, which is caused by light scattering at the boundaries “vacuole/polymer matrix”. In general, the mean particle diameter of the vacuole-initiating particles is 1 to 6 μm preferably 1.5 to 5 μm.

Typical vacuole-initiating fillers are inorganic and/or organic materials which are incompatible with polypropylene, such as aluminium oxide, aluminium sulfate, barium sulfate, calcium carbonate, magnesium carbonate, silicates such as aluminium silicate (kaolin clay) and magnesium silicate (talcum) and silicon dioxide. The typically used polymers which are incompatible with the polymers of the base layer come into consideration as organic fillers, with copolymers of cyclic olefins (COC), as described in EP-A-0 623 463, polyesters, polystyrenes, polyamides, halogenated organic polymers, calcium carbonate, polybutylene terephthalate and cyclo-olefin copolymers being particularly preferred.

In a further embodiment, the base layer may contain pigments in an amount of from 0.5 to 10% by weight, preferably 1 to 8% by weight, in particular 1 to 5% by weight. The specifications relate to the weight of the base layer.

In the sense of the present invention, pigments are incompatible particles which essentially do not result in vacuole formation upon stretching of the film and generally have an mean particle diameter of from 0.01 to 1 μm. “White pigments”, which colour the film white, are preferred. “Colour pigments”, which provide the film with a coloured or black colour, are also possible.

Typical pigments are materials such as, for example, aluminium oxide, aluminium sulfate, barium sulfate, calcium carbonate, magnesium carbonate, silicates such as aluminium silicate (kaolin clay) and magnesium silicate (talc), silicon dioxide, and titanium dioxide, of which white pigments such as calcium carbonate, silicon dioxide, titanium dioxide, and barium sulfate are preferably used. Titanium dioxide is particularly preferred. Various modifications and coatings of TiO₂ are known per se in the state of the art.

The density of the opaque film according to the invention comprising a vacuole-containing base layer can be varied within relatively wide limits and is in the range from 0.35 to 0.8 g/cm³, preferably 0.4 to 0.7 g/cm³. For embodiments which, in addition to the vacuole-initiating particles, contain pigments such as e.g. TiO₂ in the base layer, the density of the film will be comparatively higher, for example in the range from 0.4 to 0.9 g/cm³, preferably 0.45 to 0.8 g/cm³.

In a transparent embodiment, the film has a vacuole-free base layer with no pigments. In this case, the base layer is essentially composed of the previously described polymers.

In a white, vacuole-free embodiment, the base layer of the film contains no vacuole-initiating fillers, instead containing pigments, preferably TiO₂ in an amount of from 2 to 12% by weight in relation to the weight of the base layer.

The total thickness of the film is generally in a range from 20 to 120 μm, preferably 30 to 100 μm, in particular 50 to 90 μm.

For specific applications, the film may be metallized on the surface of the surface layer I. For this purpose, the usual methods, such as thermal vaporization, sputtering, electron beam vaporization and similar methods may be used. Preferably, an aluminium layer, in a thickness of from 10 to 200 nm, for example, is applied according to one of the cited methods. These embodiments are distinguished by a special metallic gloss, which may be particularly desirable for high-value label applications.

In order to improve specific properties of the polyolefin film according to the present invention even further, the base layer, the intermediate layers and also the surface layers may contain further additives in a particular effective quantity in each case, preferably antistatic agents and/or antiblocking agents and/or lubricants and/or stabilizers and/or neutralization agents, which are compatible with the propylene polymers of the base layer and the surface layers, with the exception of the antiblocking agents, which are generally incompatible and are preferably used in the surface layer or surface layers. All the following specifications of amounts in % by weight relate to the respective layer or layers to which the additive may be added.

Preferred antistatic agents are alkali-alkane sulfonates, polyether-modified, i.e., ethoxylated and/or propoxylated polydiorganic siloxanes (polydialkyl siloxanes, polyalkyl phenyl siloxanes, and the like) and/or the essentially straight-chain and saturated aliphatic, tertiary amines having an aliphatic radical comprising 10 to 20 carbon atoms, which are substituted with hydroxy-(C₁-C₄)-alkyl groups, where N,N-bis(2-hydroxyethyl) alkyl amines comprising 10 to 20 carbon atoms, preferably 12 to 18 carbon atoms, in the alkyl radical are particularly suitable. The effective amount of antistatic agent is in the range from 0.05 to 0.3% by weight. Furthermore, glycerol monostearate is preferably used as an antistatic agent in an amount of from 0.03% to 0.2%

Suitable antiblocking agents are inorganic additives such as silicon dioxide, calcium carbonate, magnesium silicate, aluminium silicate, aluminium oxide, calcium phosphate and the like and/or organic polymers such as polyamides, polyesters, polycarbonates, fully or partially cross-linked silicones and the like, silicon dioxide, aluminium silicate or fully or partially cross-linked silicones being preferred. The effective amount of antiblocking agent is in the range from 0.1 to 2% by weight, preferably 0.1 to 0.5% by weight. The mean particle size is between 1 and 6 μm, in particular 2 and 5 μm, with particles having a spherical shape, as described in EP-A-0 236 945 and DE-A-38 01 535, being particularly suitable. The antiblocking agents are preferably added to the surface layers.

Lubricants are higher aliphatic acid amides, higher aliphatic acid esters, waxes, and metal soaps, as well as polydimethylsiloxanes. The effective amount of lubricant is in the range from 0.1 to 3% by weight. The addition of higher aliphatic acid amides in the range from 0.15 to 0.25% by weight to the base layer and/or the surface layers is particularly suitable. A particularly suitable aliphatic acid amide is erucamide. The addition of polydimethylsiloxanes in the range from 0.3 to 2.0% by weight is preferred, particularly polydimethylsiloxanes having a viscosity from 10,000 to 1,000,000 mm²/s. The addition of the polydimethylsiloxanes to one or both surface layers is particularly favourable.

Stabilizers which can be employed are the conventional compounds which have a stabilizing action for ethylene, propylene and other olefin polymers. They are added in an amount of between 0.05 and 2% by weight. Particularly suitable are phenolic stabilizers, alkali/alkaline earth metal stearates and/or alkali/alkaline earth metal carbonates. Phenolic stabilizers are preferred in an amount of from 0.1 to 0.6% by weight, in particular 0.15 to 0.3% by weight, and having a molecular weight of greater than 500 g/mol. Pentaerythrityl tetrakis-3-[(3,5-di-tert-butyl-4-hydroxyphenyl)propionate] or 1,3,5-trimethyl-2,4,6-tris(3,5-di-tert-butyl-4-hydroxybenzyl)benzene are particularly advantageous.

Neutralization agents are preferably calcium stearate and/or calcium carbonate and/or synthetic dihydrotalcite (SHYT) having an mean particle size of at most 0.7 μm, an absolute particle size of less than 10 μm, and a specific surface area of at least 40 m²/g. In general, neutralization agents are used in an amount of from 50 to 1000 ppm in relation to the layer.

The invention furthermore relates to a method for producing the multilayer film according to the invention by coextrusion processes known per se, the stenter process being particularly preferred.

In the course of this method, the melts corresponding to the individual layers of the film are coextruded through a flat die, the film obtained in this way is taken off on one or more rolls for solidification, the film is subsequently stretched (oriented), the stretched film is heat-set and, if necessary, plasma-, corona- or flame-treated on the surface layer provided for treatment.

In detail, in this process, as usual in the extrusion process, the polymer or polymer mixture of the individual layers is compressed and liquefied in an extruder, where the vacuole-initiating fillers and other possibly added additives may already be present in the polymer or in the polymer mixture, respectively. Alternatively, these additives may also be incorporated via a masterbatch.

The melts are then forced simultaneously through a flat die (slot die), and the extruded multilayer film is taken off on one or more take-off rolls at a temperature of from 5 to 100° C., preferably 10 to 50° C., during which it cools and solidifies.

The film thus obtained is then stretched longitudinally and transversely to the extrusion direction, which results in orientation of the molecule chains. The longitudinal stretching is preferably carried out at a temperature of from 80 to 150° C., advantageously with the aid of two rolls running at different speeds in accordance with the target stretching ratio, and the transverse stretching is preferably carried out at a temperature of from 120 to 170° C. with the aid of a corresponding tenter frame. The longitudinal stretching ratios are in the range from 4 to 8, preferably 4.5 to 6. The transverse stretching ratios are in the range from 5 to 10, preferably 7 to 9.

The stretching of the film is followed by heat-setting (heat treatment) thereof, during which the film is held at a temperature of from 100 to 160° C. for about 0.1 to 10 seconds. The film is subsequently wound up in a conventional manner using a wind-up device.

After the biaxial stretching, one or both surface(s) of the film is (are) preferably plasma-, corona- or flame-treated by one of the known methods. The treatment intensity is generally in the range from 35 to 50 mN/m, preferably 37 to 45 mN/m, in particular 39 to 40 mN/m.

The corona treatment is carried out by passing the film between two conductor elements serving as electrodes, with such a high voltage, usually an alternating voltage (about 10,000 V and 10,000 Hz), being applied between the electrodes that spray or corona discharges are able to occur. The spray or corona discharge causes the air above the film surface to ionize and react with the molecules of the film surface, resulting in the formation of polar inclusions in the essentially non-polar polymer matrix. The treatment intensities are in the typical range, with 37 to 45 mN/m being preferred.

The film according to the invention can be employed particularly advantageously in different label applications. The curling tendency can be optimized with regard to the requirements of the specific labelling technologies. The following specific label applications are preferred:

In-mould labelling in injection moulding of containers made of thermoplastic synthetic material, preferably polyethylene or polypropylene, wherein the second side (inner side) of the film faces the container during labelling and the surface layer I forms the outer side of the labelled container. Wrap-around labels having a liquid adhesive on a section of the surface of the second side (inner side). Self-adhesive labels having an adhesive on part of the surface or on the entire surface of the second side. Spot patch labels having an adhesive on the entire surface of the second side. Blow-mould labels which, in blow forming of containers made of thermoplastic synthetic material, preferably polyethylene or polypropylene, are applied in such a way that the inner side of the film faces the container during labelling and the surface layer I forms the outer side of the label. For all the cited label applications, the film can be metallized on the surface of the first surface layer, if necessary.

The following measuring methods were used to characterize the raw materials and the films:

Curling Tendency

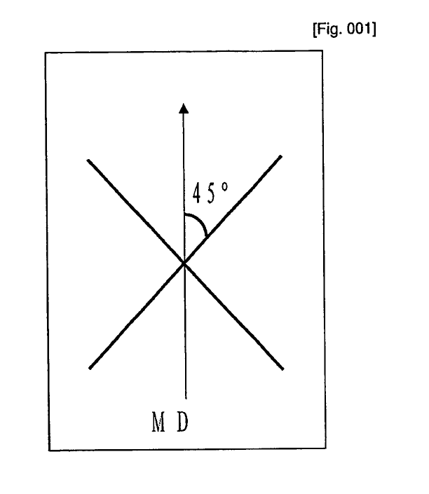

The curling tendency was determined on a DIN A4 sheet, which is cut from the film in the running direction of the machine (long side of the DIN A4 sheet in MD direction). The film is laid with the surface I on a flat base (surface II faces upward). The sheet is cut crosswise in the middle using a cutting blade. Each cut has a length of approx. 10 cm. The cuts are arranged in such a way that they are perpendicular to one another and are at a 45° angle to the running direction of the machine (MD) (FIG. 1). Subsequent to performing the cross cut, the resulting tips bend upward (toward side II) in case of an existing curling tendency. The distance of the highest tip to the base is used to indicate the value of the curling tendency toward side II. The tendency to curl toward the other side I is determined by reversed placing and analogue execution.

Melt Flow Index

The melt flow index was measured according to DIN 53735 under a load of 21.6 N and 230° C.

Light Transmission

The light transmission was measured in accordance with ASTM-D 1003-77.

Turbidity

The turbidity of the film was measured in accordance with ASTM-D 1003-52.

Gloss

The gloss was determined in accordance with DIN 67530. The reflector value was measured as the optical characteristic for the surface of a film. In accordance with the ASTM-D 523-78 and ISO 2813 standards, the angle of incidence was set at 20° (or 60° for matt surfaces). A light beam hits the planar test surface at the set angle of incidence and is reflected or scattered thereby. The light beams hitting the photoelectronic receiver are displayed as proportional electrical quantity. The measurement value is dimensionless and must be quoted together with the angle of incidence.

Opacity and Degree of Whiteness

The opacity and degree of whiteness were determined with the aid of the electronic remission photometer. The opacity is determined in accordance with DIN 53146. The degree of whiteness is defined as WG=RY+3 RZ−3 RX, WG being the degree of whiteness, and RY, RZ, RX being corresponding reflection factors when using the Y, Z, and X colour measurement filters. A blank made of barium sulfate (DIN 5033 part 9) is used as the white standard. An extensive description is available, e.g. in Hansl Loos “Farbmessungen” [Colour measurements], Verlag Beruf und Schule, Itzehoe (1989).

Determination of the Ethylene Content

The ethylene content of the copolymers was determined using ¹³C NMR spectroscopy. The measurements were carried out using a nuclear resonance spectrometer from Bruker Avance 360. The polymer to be characterized was dissolved in tetracholorethane, resulting in a 10% mixture. Octamethyltetrasiloxane (OMTS) was added as a reference standard. The nuclear resonance spectrum was measured at 120° C. The spectra were analyzed as described in J. C. Randall, Polymer Sequence Distribution (Academic Press, New York, 1977).

The distribution factor VF is also determined from the NMR spectrum and is defined as

$$VF = \frac{Ci}{Cg - Ci}$$

with Cg denoting the total ethylene content of the copolymer in % by weight and Ci denoting the proportion of ethylene in % by weight present as isolated ethylene proportion, i.e. a single ethylene unit is located between two propylene units.

Melting Point and Melting Enthalpy

The melting point and the melting enthalpy were determined using DSC (differential scanning calorimetry) measurement (DIN 51007 and DIN 53765). Several milligrams (3 to 5 mg) of the raw material to be characterized were heated in a differential calorimeter at a heating speed of 20° C. per minute. The thermal flux was plotted against the temperature and the melting point was determined as the maximum of the melting curve and the melting enthalpy was determined as the area of the respective melting peak. The values were determined from the curves of the second melting.

Density

The density was determined in accordance with DIN 53479, method A.

Initial Tear Resistance

To determine the initial tear resistance, the film comprising the surface layer according to the invention was sealed against a transparent sealable packaging film (type Trespaphan GND 30). For this purpose, two 15 mm wide film strips were laid one on top of another and sealed at a temperature of 130° C. and a sealing time of 0.5 sec and a sealing pressure of 10 N/cm² in a sealing device HSG/ETK from Brugger. The two strips were subsequently pulled apart according to the T-peel method. In this case, the force-distance diagram during peeling was measured in the usual way. The maximum force prior to tearing of the sealed sample was specified as the initial tear resistance.

Surface Tension

The surface tension was determined by the ink method according to DIN 53364.

The invention will now be explained by the following examples.

### EXAMPLE 1

A five-layer precursor film was extruded using the coextrusion process from a slot die at an extrusion temperature of 240 to 250° C. This precursor film was first taken off on a cooling roll and cooled. The precursor film was subsequently oriented in the longitudinal and transverse directions and finally set. The surface of the surface layer I was pre-treated by means of corona to increase the surface tension. The five-layer film had a layer structure comprising surface layer I/first intermediate layer/base layer/intermediate layer II/second surface layer. The individual layers of the film had the following composition:

Surface Layer I 0.7 μm:

100% by weight of ethylene-propylene copolymer having an ethylene proportion of 1.7% by weight (in relation to the copolymer) and a melting point of 151° C.; and a melt flow index of 8.5 g/10 min at 230° C. under a load of 2.16 kg (DIN 53735) and a melting enthalpy of 96.9 J/g.

First Intermediate Layer 4.5 μm:

94% by weight of propylene homopolymer (PP) having an n-heptane-soluble content of 4.5% by weight (based on 100% PP) and a melting point of 165° C.; a melt flow index of 3.2 g/10 min at 230° C. under a load of 2.16 kg (DIN 53735).

6% by weight of TiO₂, mean particle diameter of from 0.1 to 0.3 μm.

Base Layer

85.6% by weight of propylene homopolymer (PP) having an n-heptane-soluble content of 4.5% by weight (based on 100% PP) and a melting point of 165° C.; and a melt flow index of 3.2 g/10 min at 230° C. under a load of 2.16 kg (DIN 53735) and

14% by weight of calcium carbonate, mean particle diameter of 3.5 μm

0.2% by weight of tertiary aliphatic amine as antistatic agent (Armostat 300)

0.2% by weight of erucamide as lubricant (ESA)

Intermediate Layer II 1.4 μm:

85% by weight of ethylene-propylene copolymer having an ethylene proportion of 1.7% by weight (in relation to the copolymer) and a melting point of 151° C.; and a melt flow index of 8.5 g/10 min at 230° C. under a load of 2.16 kg (DIN 53735) and a melting enthalpy of 96.9 J/g and

15% by weight of propylene homopolymer (PP) having an n-heptane-soluble content of 4.5% by weight (based on 100% PP) and a melting point of 165° C.; a melt flow index of 3.2 g/10 min at 230° C. under a load of 2.16 kg (DIN 53735).

Second Surface Layer 3 μm:

65% by weight of ethylene-propylene copolymer having an ethylene proportion of 4% by weight (in relation to the copolymer) and a melting point of 136° C.; and a melt flow index of 7.3 g/10 min at 230° C. under a load of 2.16 kg (DIN 53735) and a melting enthalpy of 64.7 J/g and

34.8% by weight of polyethylene having a density of 0.93 g/cm³ and a melt flow index (190° C. and 50 N) of 0.8 g/10 min and

0.2% by weight of antiblocking agent having a mean particle diameter of approx. 4 μm

All layers of the film additionally contained stabilizer and neutralization agent in typical amounts.

The following conditions and temperatures were specifically selected for the production of the film:

Extrusion: extrusion temperature approx. 245° C.

Cooling roll: Temperature 25° C.,

Longitudinal stretching: T=105° C.

Longitudinal stretching by the factor 5

Transverse stretching T=149° C.

Transverse stretching by the factor 9

Setting T=143° C.

The film was surface treated on the surface of the surface layer I by means of corona and had a surface tension of 38 mN/m. The film had a thickness of 75 μm and a density of 0.55 g/cm³.

### EXAMPLE 2

A film was produced as in Example 1 In contrast to Example 1, the thickness of the intermediate layer II was increased from 1.4 μm to 2 μm.

### EXAMPLE 3

A film was produced as in Example 2 In contrast to Example 2, the mini-copolymer content of the intermediate layer II was reduced to 70% by weight and the proportion of propylene homopolymer accordingly increased to 30% by weight.

### EXAMPLE 4

A film was produced as in Example 1 In contrast to Example 1, the thicknesses and composition of the intermediate layers of Example 1 were changed. The thicknesses and compositions of the remaining layers were left unchanged.

First Intermediate Layer 1.5 μm:

94% by weight of propylene homopolymer (PP) having an n-heptane-soluble content of 4.5% by weight (based on 100% PP) and a melting point of 165° C.; a melt flow index of 3.2 g/10 min at 230° C. under a load of 2.16 kg (DIN 53735).

6% by weight of TiO₂ having a mean particle diameter of from 0.1 to 0.3 μm.

Intermediate Layer II 4 μm:

55% by weight of ethylene-propylene copolymer having an ethylene proportion of 1.7% by weight (in relation to the copolymer) and a melting point of 151° C.; and a melt-flow index of 8.5 g/10 min at 230° C. under a load of 2.16 kg (DIN 53735) and a melting enthalpy of 96.9 J/g.

45% by weight of propylene homopolymer (PP) having an n-heptane-soluble content of 4.5% by weight (based on 100% PP) and a melting point of 165° C.; a melt-flow index of 3.2 g/10 min at 230° C. under a load of 2.16 kg (DIN 53735).

### EXAMPLE 5

A film was produced as described in Example 4 In contrast to Example 4, the thickness of the intermediate layer II was reduced from 4 μm to 2 μm.

### COMPARATIVE EXAMPLE

A film was produced as described in Example 2 In contrast to Example 2, the composition of the intermediate layer II was changed while the thickness was left unchanged at 2 μm. The composition of the intermediate layer II now was as follows:

100% by weight of propylene homopolymer (PP) having an n-heptane-soluble content of 4.5% by weight (based on 100% PP) and a melting point of 165° C.; and a melt-flow index of 3.2 g/10 min at 230° C. under a load of 2.16 kg (DIN 53735).

### COMPARATIVE EXAMPLE 2

A film was produced as described in Example 2 In contrast to Example 2, the mini-copolymer content of the intermediate layer II was reduced to 70% by weight to 30% by weight and the content of propylene homopolymer accordingly increased from 30% by weight to 70% by weight.

### COMPARATIVE EXAMPLE 3

A film was produced as described in Comparative Example 2. In contrast to Comparative Example 2, the composition of the intermediate layer II and of the surface layer I were changed:

Surface Layer I 0.7 μm:

100% by weight of ethylene-propylene copolymer having an ethylene proportion of 4% by weight (in relation to the copolymer) and a melting point of 136° C.; and a melt flow index of 7.3 g/10 min at 230° C. under a load of 2.16 kg (DIN 53735) and a melting enthalpy 64.7 J/g.

Intermediate Layer II 2 μm:

100% by weight of propylene homopolymer (PP) having an n-heptane-soluble content of 4.5% by weight (based on 100% PP) and a melting point of 165° C.; a melt-flow index of 3.2 g/10 min at 230° C. under a load of 2.16 kg (DIN 53735).

The properties of the films described in the examples and comparative examples are compiled in Table 1.

Table 1

TABLE 1

| | Tendency | Tendency | | | | |
|---|---|---|---|---|---|---|
| | to curl | to curl | | | | |
| | toward | toward | | | Thick- | |
| | side II | side I | Initial | | ness | Mini- |
| Ex- | (glossy | (matt | tear | Gloss | of | copolymer |
| am- | side) | side) | resistance | 20° SL | IL II | in IL |
| ple | in mm | in mm | N/15 mm | I in % | in μm | II in |
| Ex. 1 | ~0 | ~0 | 3.5 | 50 | 1.4 | 85 |
| Ex. 2 | none | 5 | 3.4 | 50 | 2.0 | 85 |
| Ex. 3 | none | 0.2 | 3.5 | 50 | 2.0 | 70 |
| Ex. 4 | 0.3 | none | 2.9 | 27 | 4.0 | 55 |
| Ex. 5 | 6 | none | 2.8 | 27 | 2.0 | 55 |
| CE 1 | none | 15 | 3.6 | 49 | 2.0 | 0 |
| CE 2 | none | 12 | 3.6 | 50 | 2.0 | 30 |
| CE 3 | 2 | none | 2.0 | 45 | 2.0 | 0 |

1. Multi-layered biaxially oriented polypropylene film comprising a base layer and a surface layer I on a first side of the film, which contains at least 80 to 100% by weight of a propylene-ethylene copolymer, characterized in that at least one further layer II is applied to the opposing second side, which contains between 40 and 100% by weight of a propylene-ethylene copolymer, with the propylene-ethylene copolymer of the two layers containing a maximum of 2.5% by weight of ethylene and having a melting point in the range from 145 and 160° C.

2. Film according to claim 1, characterized in that the surface layer I has a thickness of from 0.1 to 3 μm.

3. Film according to claim 1 wherein the surface layer I of the film contains at least 95 to <100% by weight of the propylene-ethylene copolymer.

4. Film according to claim 1, wherein the layer II contains as further polyolefin 0 to 60% by weight of a propylene homopolymer, propylene copolymer, propylene terpolymer or mixtures therefrom.

5. Film according to claim 1, wherein the layer II is an intermediate layer II, onto which a second surface layer is applied as further layer.

6. Film according to claim 5, characterized in that the intermediate layer II contains >80 to 100% by weight of the propylene-ethylene copolymer and has a thickness of 0.6 to 6 μm and is at least 0.5 to 3 μm thicker than the surface layer I.

7. Film according to claim 5, wherein the intermediate layer II contains 40 to 80% by weight of the copolymer and has a thickness of 1.1 to 11 μm and is at least 1 to 6 μm thicker than the surface layer I.

8. Film according to claim 5, wherein the intermediate layer II contains lubricants, pigments and/or antistatic agents.

9. Film according to claim 1, wherein the layer II is a surface layer, which contains >80 to 100% by weight of the copolymer and has a thickness of 0.3 to 4.0 μm and is at least 0.2 to 1.0 μm thicker than the surface layer I.

10. Film according to claim 1, wherein the layer II is a surface layer, which contains 40 to 80% by weight of the copolymer and has a thickness of 1.1 to 5.0 μm and is at least 1 to 2 μm thicker than the surface layer I.

11. Film according to claim 1, wherein the propylene-ethylene copolymer has an ethylene content of from 0.3 to <2.0% by weight and a melting point in the range from 148 to 155° C. and a melting enthalpy of from 80 to 110 J/g.

12. Film according to claim 1, wherein a first intermediate layer made of propylene homopolymer is applied between the surface layer I and the base layer.

13. Film according to claim 12, wherein the first intermediate layer contains TiO2 and/or antistatic agents.

14. Film according to claim 1, wherein the base layer is transparent.

15. Film according to claim 1, wherein the base layer contains vacuoles and has a density in the range from 0.35 to 0.8 g/cm3.

16. Film according to claim 15, characterized in that the base layer contains 70 to 95% by weight of propylene homopolymer and 5 to 30% by weight of vacuole-initiating fillers.

17. Film according to claim 1, wherein the base layer contains TiO2.

18. Film according to claim 1, wherein the surface layer I is provided with printing which does not cover its entire area.

19. Film according to claim 1, wherein the surface layer I is metallized.

20. Label comprising a film according to claim 1, wherein the surface layer I forms the outer side of the label.

21-25. (canceled)

26. A process of in-mold labelling in injection molding of containers made of thermoplastic synthetic material which comprises labeling the film according to claim 1 on the side of the film opposing the first surface layer faces the container and the first surface layer forms the outer side of the label.

27. A wrap-around label which comprises the film as claimed in claim 1 and a liquid adhesive is which applied to a section of the surface of the second side.

28. A self-adhesive label which comprises the film as claimed in claim 1 and an adhesive which is applied to part of the surface or to the entire surface of the second side.

29. A spot patch label which comprises the film as claimed in claim 1 and an adhesive which is applied to the entire surface of the second side.

30. A process for blow-mold labelling in blow forming of containers made of thermoplastic synthetic material which comprises labeling the film according to claim 1 on the side of the film opposing the first surface layer faces the container and the first surface layer forms the outer side of the label.
